(19) United States
(12) Patent Application Publication
(10) Pub. No.: US 2026/0092684 A1
(43) Pub. Date: Apr. 2, 2026

(54) Indicator Light for a Technical Device as Well as Technical Device

(71) Applicant: Binder GmbH, Tuttlingen (DE)

(72) Inventors: Ewald STORZ, Rietheim-Weilheim (DE); Peter Michael BINDER, Altnau (CH)

(73) Assignee: Binder GmbH, Tuttlingen (DE)

(21) Appl. No.: 19/346,888

(22) Filed: Oct. 1, 2025

(30) Foreign Application Priority Data
Oct. 2, 2024 (DE) 1020241285761

(51) Int. Cl. F21S 4/28; F21Y 103/10; F21Y 103/20; F21Y 107/90; F21Y 115/10

(52) U.S. Cl. CPC F21S 4/28; F21Y 2103/10; F21Y 2103/20; F21Y 2107/90; F21Y 2115/10

(57) ABSTRACT

An indicator light for a device includes a housing shell and an illuminant disposed within the housing shell. The housing shell has a shell opening and a margin extending peripherally about the shell opening. The margin includes a contact segment and a exit segment, where the exit segment is set back with respect to the contact segment toward the housing shell. When the indicator light is mounted on an external wall with the contact segment positioned against the wall, an exit opening is between the set-back exit segment and the external wall through which light from the illuminant can pass. The shell opening is triangular, making the indicator light suitable for mounting on upper corners of technical devices. The illuminant may be a LED luminant strip. A climate simulation chamber may include the indicator light mounted on its outer wall to provide status indication through light scattering and reflection.

### CROSS REFERENCE TO RELATED APPLICATIONS

This application claims priority under 35 U.S.C. § 119 (a) to German Patent Application No. 10 2024 128 576.1, filed Oct. 2, 2024, the entire disclosure of which is hereby incorporated by reference.

### FIELD OF DISCLOSURE

The application relates to an indicator light for a technical device as well as a technical device with such indicator light.

### BACKGROUND

Indicator lights are intended to provide information about the status of a technical device. For this purpose they can, as a rule, emit light in different colors. For example a fault-free operating status can be indicated with green light, a maintenance status with yellow light and a fault status with red light.

Such indicator lights are known in various physical forms. There are in particular indicator lights that are very flat in form such that they can not only be aesthetically well integrated into the appearance of a technical device but are also advantageous with respect to their space requirements. Indicator lights projecting far beyond the contour of a technical device can thereby be avoided and the risk of accidents can therewith be reduced accordingly. Reference may be made, for example, to the indicator lights disclosed in DE 10 2017 204 011 A1 or EP 4 336 154 A2.

### SUMMARY

In order to be able to attain sufficient visibility of the light emitted by the indicator light in spite of the flat structural shape, the known systems attempt to provide the largest possible illumination area in spite of the flat structural form. For this purpose optical fibers and/or relatively long strip lights are employed. Such systems are therefore tied to comparatively high component and assembly expenditures.

The application therefore addresses the problem of providing an indicator light with which a flat structural shape and good visibility can be realized and which, moreover, can be fabricated cost-effectively. The application further addresses the problem of providing a technical device with a corresponding indicator light.

According to the disclosure the problems are resolved through an indicator light with the characteristics described herein as well as through a technical device with the characteristics described herein.

Advantageous embodiments and further developments are described herein.

An indicator light for a technical device comprises a housing shell and an illuminant disposed in the housing shell, wherein the housing shell comprises a shell opening and a margin extending peripherally about the shell opening with at least one contact segment and at least one exit segment. The at least one exit segment is herein set back with respect to the at least one contact segment. The at least one exit segment is preferably set back with respect to the at least one contact segment toward the housing shell. A housing of the indicator lights preferably encompasses exclusively the housing shell.

The indicator light is preferably intended to be disposed with the at least one contact segment on an external wall not belonging to the indicator light. The external wall can be, for example, an outer wall of the technical device. Alternatively, the housing of the indicator light can comprise a housing cap which at least partially closes the shell opening. In this case the housing cap and/or the at least one contact segment can be provided for disposition on the external wall.

Thereby that the at least one exit segment is set back with respect to the at least one contact segment, in the proximity of the at least one exit segment between the housing shell and the external wall an exit opening can be formed through which the light emitted by the luminant can pass out of the indicator light. The indicator light is therewith developed such that the light emitted by the illuminant can pass out of the indicator light directly at the external wall. The light passing out of the indicator light can in this way be scattered and/or reflected on the external wall whereby, with a flat structural form of the indicator light. good visibility can be attained with simple means. The indicator light is in particular preferably free of additional light conductors.

The at least one contact segment is preferably completely disposed in precisely one contact plane. Each of the at least one contact segments is especially preferably disposed in the same contact plane. The indicator light can thereby be especially well suited for contact on a flat external wall. The at least one exit segment is preferably set back with respect to the contact plane toward the housing shell. The shell opening is preferably disposed in the contact plane.

The at least one exit segment can be disposed parallel to the at least one contact segment. With the contact of the indicator light on the external wall in the proximity of the at least one exit segment, the exit opening can thereby be developed in the form of a slot.

In an embodiment, the margin comprises several exit segments. Each of the exit segments herein comprises preferably the above described features of the at least one exit segment. Thereby that the margin is developed such that it extends peripherally, based on the existence of several exit segments it follows that the margin comprises several contact segments. Each of the exit segments comprises herein preferably the above described features of the at least one exit segment.

The shell opening can substantially be developed as a polygon with several sides. The formulation “substantially” here and in the following refers in particular to the corners of the polygon being developed to be rounded off and/or that the sides of the polygon can be developed to be straight and/or curved.

Each of the exit segments is preferably disposed precisely on one of the sides of the polygon. On the each of the sides at most one of the exit segments is disposed. Thereby in particular the visibility from several sides of the light passing out of the indicator light can be attained.

In an embodiment, the shell opening is developed substantially as a triangle, preferably as a right-angled triangle. The indicator light can therewith advantageously be developed for disposition on an upper corners of the technical device. The upper corner of the technical device is frequently right-angled such that the indicator light with a shell opening developed as a right-angled triangle can especially advantageously be suited for placement on the upper corner of the technical device.

The margin preferably comprises a first exit segment and a second exit segment, wherein the first exit segment is disposed on a first leg of the triangle and the second exit segment on a second leg of the triangle. If the shell opening is developed as a right-angled triangle with two catheti and a hypotenuse, the first exit segment is preferably disposed on the hypotenuse and the second exit segment on one of the catheti. By disposing the indicator light on a right-angled corner of the technical device thereby, given two exit openings direct visibility from three directions of the light passing out of the indicator can thereby be attained. The first exit segment and the second exit segment preferably comprise the features of the above described exit segment.

The illuminant can be developed as a luminant strip studded on both sides with LEDs. With several exit openings disposed in particular on different sides of the housing shell sufficient light emission through each of the exit openings can thereby be attained. The luminant strip is preferably developed such that it is rigid. The luminant strip can be developed as a circuit board. The indicator light preferably comprises precisely one illuminant.

The luminant strip is especially preferably disposed parallel to one of the at least one exit segment. For example, the luminant strip can be disposed parallel to the first exit segment disposed on the hypotenuse of the shell opening, The light passing out at the at least one exit segment can preferably be influenced by assigning the luminant strip to the at least one exit segment. Embodiments are therefore also conceivable in which the luminant strip is not disposed parallel to the at least one exit segment, in particular not parallel to the hypotenuse.

In a further development, the housing shell comprises an inner side which is developed to be light-tight and/or reflective. Due to a light-tight inner side an impairment of the information conveyed on an outer side of the housing shell by the light emitted from the illuminant can be avoided. Through a reflective inner side that fraction of the light emitted by the illuminant which is absorbed by the housing shell can be reduced. In particular, on the inner side of the housing shell a light-tight and/or reflecting varnish can be applied.

The housing shell can comprise an outer shell and an inner shell, wherein the illuminant is preferably disposed in the inner shell. Thereby modular structuring of the indicator light can be attained such that, for example, the inner shell could be combined with different outer shells. The inner shell is preferably developed to be light-tight and/or reflective. The inner shell is especially preferably developed of a light-tight and/or reflective material.

A technical device comprises an outer wall and the above described indicator light, wherein the indicator light is disposed on the technical device such that the at least one contact segment is disposed on the outer wall. The indicator light is preferable herein disposed directly on an outer surface of the outer wall. The outer wall is preferably developed to be flat such that between the outer wall and the at least one exit segment a slot-form exit opening is formed. The indicator light is especially preferably disposed on an upper corner of an outer wall of the technical device. As “outer wall” are here and in the following preferably denoted vertically disposed segments of the outer wall. If the shell opening is developed as a right-angled triangle, the two catheti are preferably each disposed parallel to two edges of the outer wall that are at right angles with respect to each other.

The outer wall is preferably developed to be white and/or reflective. On a reflective outer wall the light passing out through the exit opening can be scattered on a reflective outer wall such that in particular good visibility of the exiting light can be attained. In front of a white outer wall the color of the light passing out through the exit opening can be perceived unchanged.

In an embodiment, the technical device is developed as a simulation chamber, especially preferably as a climate chamber.

### BRIEF DESCRIPTION OF THE DRAWINGS

An embodiment example will be explained in conjunction with the following Figures. Therein depict:

FIG. 1 illustrates a schematic front view of an embodiment example of an indicator light,

FIG. 2 illustrates a schematic rear view of the embodiment example depicted in FIG. 1,

FIG. 3 illustrates a schematic view of an embodiment example of a simulation chamber with the indicator light shown in FIGS. 1 and 2.

### DETAILED DESCRIPTION

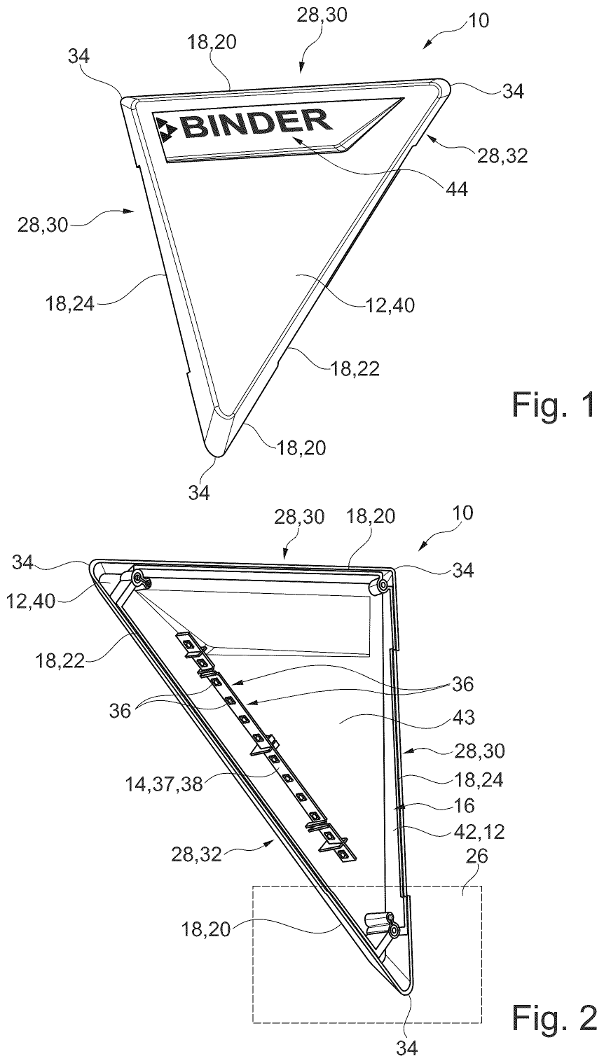

FIGS. 1 to 3 show different views of different embodiment examples. For the sake of clarity, not all reference symbols are used in each Figure. For same and functionally same parts the same reference symbols are used.

FIG. 1 shows a front view of an embodiment example of an indicator light 10 for a technical device. Due to the selected view, in FIG. 1 only a housing shell 12 of the indicator light 10 is visible. A housing of the indicator light 10 preferably comprises exclusively the housing shell 12.

The rear view depicted in FIG. 2 of the embodiment example shown in FIG. 1 shows that in the housing shell 12 an illuminant 14 is disposed. The view in FIG. 2 also shows that the housing shell 12 comprises a shell opening 16 and a margin 18 peripherally to the shell opening 16. The margin 18 comprises preferably two contact segments 20 as well as a first exit segment 22 and a second exit segment 24, wherein the two exit segments 22, 24 are set back toward the housing shell 12 with respect to the contact segments 20.

The contact segments 20 are preferably completely disposed in precisely one contact plane 26 which is depicted rudimentarily in FIG. 2. The indicator light 10 can thereby be especially well suited for contact on a flat external wall. The two exit segments 22, 24 are preferably set back with respect to the contact plane 26 toward the housing shell 12. The first exit segment 22 and the second exit segment 24 can each be disposed parallel to the contact segments 20. FIG. 2 also shows that the shell opening 16 is preferably disposed in the contact plane 26.

FIG. 2 shows that the shell opening 16 is preferably substantially developed as a right-angled triangle with three legs 28, namely two catheti 30 and one hypotenuse 32. The shell opening 16 accordingly comprises preferably three corners 34 which can be rounded off. The first exit segment 22 is preferably disposed on the hypotenuse 32 and the second exit segment 24 on one of the catheti 30.

As FIG. 2 further shows the illuminant 14 can be developed as a luminant strip 38, developed as a circuit board 37, studded on both sides with LEDs 36. The luminant strip 38 is especially preferably disposed parallel to the first exit segment 22 disposed on the hypotenuse 32 of the shell opening 16.

The housing shell 12 can comprise an outer shell 40 and an inner shell 42. While in FIG. 1 only the outer shell 40 is visible, FIG. 2 shows the inner shell 42, disposed within the outer shell 40, in which the illuminant 14 is preferably disposed. The inner shell 42 is preferably developed light-tight and reflective such that an inner side 43 of the housing shell 12 is developed light-tight and reflective. Due to the light tightness of the inner shell 42 impairment of the information 44 conveyed on the outer shell 40 through the light emitted by the illuminant 14 can be avoided. Due to the reflective property of the inner shell 42 the fraction of the light emitted by the illuminant 14 which is absorbed by the housing shell 12 can be decreased.

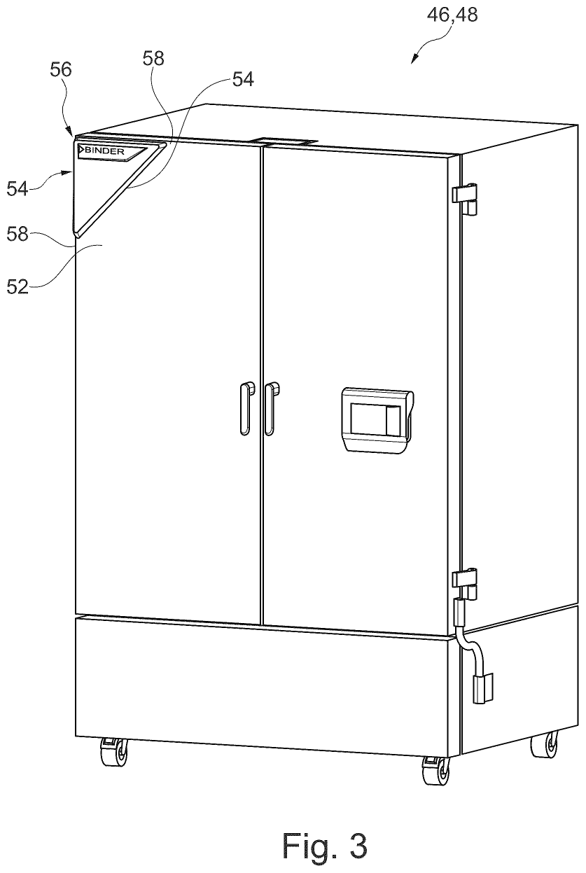

In FIG. 3 is depicted a technical device 46, namely a simulation chamber 48, depicted with an outer wall 52 and the indicator light 10. The indicator light 10 can be disposed on an outer wall 52 of the simulation chamber 48 such that the contact segments 20 are disposed directly on the outer wall 52.

In the proximity of the indicator light 10 the outer wall 52 is preferably developed to be flat. In combination with the disposition of the exit segments 22, 24 parallel to the contact segments 20 in this way between the outer wall 52 of the simulation chamber 48 and each of the two exit segments 22, 24 a slot-form exit opening 54 can be developed. Through the exit openings 54 light emitted by the illuminant 14 can pass out of the indicator light 10 directly at the outer wall 52 of the simulation chamber 48. The light passing out of the indicator light 10 can in this way be scattered and/or reflected on the outer wall 52 whereby with a flat structural form of the indicator light 10 good visibility of the exiting light can be attained.

As FIG. 3 shows the indicator light 10 is especially preferably disposed on an upper corner 56 of the outer wall 52 such that the two catheti 30 are each disposed parallel to two edges 58 of the outer wall 52 disposed at a right angle with respect to one another. In the embodiment example depicted in FIG. 3 therewith the light passing out of the first exit segment 22, disposed on the hypotenuse 32, from the indicator light 10 is visible from below and from the right. The second exit segment 24 is preferably disposed on one of the vertical edges 58. In the depiction of FIG. 3 the light passing out of the indicator light 10 is therewith additionally visible from the left. Overall, through such configuration with the two exit openings 54 the direct visibility from three directions of the light passing out of the indicator light 10 can be attained.

The outer wall 52 of the simulation chamber 48 shown in FIG. 3 is preferably developed white and reflective. Thereby good scattering of the light exiting through the exit opening 54 can be attained without change of its color. Therewith in particular good indirect visibility of the exiting light and correct perception of the information content intrinsic to the color can be attained.

### LIST OF REFERENCE SYMBOLS

10 Indicator light
12 Housing shell
14 Illuminant
16 Shell opening
18 Margin
20 Contact segment
22 First exit segment
24 Second exit segment
26 Contact plane
28 Side
30 Cathetus
32 Hypotenuse
34 Corner
36 LED
37 Circuit board
38 Luminant strip
40 Outer shell
42 Inner shell
43 Inner side
44 Information
46 Technical device
48 Simulation chamber
52 Outer wall
54 Exit opening
56 Upper corner
58 Edge

We claim:

1. An indicator light for a device, comprising:
a housing shell; and
an illuminant disposed in the housing shell;
wherein the housing shell comprises a shell opening and a margin peripherally extending about the shell opening with a contact segment and at least one exit segment, and wherein the at least one exit segment is set back with respect to the contact segment.

2. The indicator light of claim 1, wherein the contact segment is disposed entirely in precisely one contact plane.

3. The indicator light of claim 1, wherein the at least one exit segment is disposed parallel to the contact segment.

4. The indicator light of claim 1, wherein the margin comprises a plurality of exit segments.

5. The indicator light of claim 1, wherein the shell opening is substantially a polygon with several sides.

6. The indicator light of claim 4, wherein the shell opening is substantially a polygon with several sides, and each exit segment is disposed on precisely one of the sides of the polygon.

7. The indicator light of claim 5, wherein the shell opening is substantially a triangle.

8. The indicator light of claim 7, wherein the shell opening is substantially a right-angled triangle.

9. The indicator light of claim 7, wherein the margin comprises a first exit segment and a second exit segment, wherein the first exit segment is disposed on a first side of the triangle and the second exit segment is disposed on a second side of the triangle.

10. The indicator light of claim 1, wherein the illuminant is a luminant strip studded on both sides with LEDs.

11. The indicator light of claim 10, wherein the luminant strip is disposed parallel to the at least one exit segment.

12. The indicator light of claim 1, wherein the housing shell comprises an inner side which is light-tight and/or reflective.

13. The indicator light of claim 1, wherein the housing shell comprises an outer shell and an inner shell, wherein the illuminant is disposed in the inner shell.

14. The indicator light of claim 1, further comprising:
an outer wall; and
wherein the indicator light is disposed on the device such that the contact segment is disposed on the outer wall.

15. The indicator light of claim 1, wherein the outer wall is white and/or reflective.

16. The indicator light of claim 1, wherein the device is a simulation chamber.

17. An indicator light system for a technical device, comprising:
a housing shell having a substantially triangular shell opening;
an illuminant disposed in the housing shell, wherein the illuminant comprises a luminant strip studded on both sides with LEDs and disposed parallel to a first side of the triangular shell opening;
wherein the housing shell comprises a margin peripherally extending about the triangular shell opening with a contact segment and at least two exit segments, wherein a first exit segment is disposed on the first side of the triangular shell opening and a second exit segment is disposed on another side of the triangular shell opening, and wherein the at least two exit segments are each set back with respect to the contact segment;
wherein the housing shell comprises an inner side that is opaque;
wherein the housing shell comprises an outer shell and an inner shell, and the illuminant is disposed in the inner shell; and
wherein the indicator light system is configured for mounting on a corner of a climate chamber such that when the contact segment is positioned against an outer wall of the climate chamber, slot-form exit openings are formed between the set-back exit segments and the outer wall through which light from the illuminant passes to provide multi-directional visibility.
